(19) United States
(12) Patent Application Publication
(10) Pub. No.: US 2021/0321238 A1
(43) Pub. Date: Oct. 14, 2021

(54) SYSTEM FOR DATA COMMUNICATION IN A NETWORK OF LOCAL DEVICES

(71) Applicant: SIEMENS AKTIENGESELLSCHAFT, München (DE)

(72) Inventors: Thomas Baierlein, Nürnberg (DE); Maik Boche, Oberasbach (DE); Aila Kleemann, Adelsdorf (DE); Dmitry Simakov, Karlsruhe (DE)

(21) Appl. No.: 17/272,928

(22) PCT Filed: Sep. 18, 2019
(86) PCT No.: PCT/EP2019/074925

§ 371 Date: Mar. 2, 2021

(30) Foreign Application Priority Data
Oct. 2, 2018 (EP) 18198107.7

(51) Int. Cl. H04W 4/70; H04W 4/38; H04W 88/16; H04W 80/02

(52) U.S. Cl. CPC H04W 4/70; H04W 80/02; H04W 88/16; H04W 4/38

(57) ABSTRACT

A system for data communication in a network between two or more local devices and a cloud computing platform, in which data collected and/or stored on at least one local device are transmitted to a cloud computing platform using at least one communication protocol and processed by a translation algorithm executed in a translator module (170) of the cloud computing platform, is provided. The data is transferred to at least one other communication protocol that is processable or executable by at least one second local device and submitted to the at least one second device.

This application is the National Stage of International Application No. PCT/EP2019/074925, filed Sep. 18, 2019, which claims the benefit of European Patent Application No. EP 18198107.7, filed Oct. 2, 2018. The entire contents of these documents are hereby incorporated herein by reference.

### BACKGROUND

The present embodiments generally relate to a system for data communication in a network between two or more local devices and a cloud computing platform, in which data collected and/or stored on at least one local device are transmitted to a cloud computing platform.

There is an increasing trend of industrial automation systems, assets, machines, sensors, mobile devices, etc. in all fields of the industrial production, energy, transportation, and in other areas such as banking, retail, hospitality, and medical health care systems being connected via network connections to the Industrial Internet of Things (IIoT) directly or via cloud gateways. Data analytics (e.g., data mining, deep learning, artificial intelligence) is a core aspect in this whole area of connected things and generates a new level of knowledge and usability. According to statistical predictions, about 50 billion interconnected devices are forecast for 2020 worldwide. This corresponds to about 6.5 interconnected devices per person. However, all these different devices communicate with each other using different formats and protocols.

In systems based on cloud computing technology, a large number of devices is connected to a cloud computing system via the Internet. The devices may be located in a remote facility connected to the cloud computing system. For example, the devices may include, or consist of, equipment, sensors, actuators, robots, and/or machinery in an industrial set-up(s). The devices may be medical devices and equipment in a healthcare unit. The devices may be home appliances or office appliances in a residential/commercial establishment.

The cloud computing system may enable remote configuring, monitoring, controlling, and maintaining connected devices (e.g., ‘assets’). Also, the cloud computing system may facilitate storing large amounts of data periodically gathered from the devices, analyzing the large amounts of data, and providing insights (e.g., Key Performance Indicators, Outliers) and alerts to operators, field engineers, or owners of the devices via a graphical user interface (e.g., of web applications). The insights and alerts may enable controlling and maintaining the devices, leading to efficient and fail-safe operation of the devices. The cloud computing system may also enable modifying parameters associated with the devices and issues control commands via the graphical user interface based on the insights and alerts.

The cloud computing system may include a plurality of servers or processors (e.g., ‘cloud infrastructure’) that are geographically distributed and connected with each other via a network. A dedicated platform (hereinafter referred to as ‘cloud computing platform’) is installed on the servers/processors for providing above functionality as a service (hereinafter referred to as ‘cloud service’). The cloud computing platform may include a plurality of software programs executed on one or more servers or processors of the cloud computing system to enable delivery of the requested service to the devices and users of the devices.

One or more application programming interfaces (APIs) are deployed in the cloud computing system to deliver various cloud services to the users.

The communication between the IIoT devices may be performed at the edge of the IIoT devices, the IIoT gateways, or the cloud computing platform as the central computing infrastructure. If communication between IIoT devices is performed at the edge of the local IIoT devices itself, the IIoT devices are to be able to understand each other, which provides that the IIoT devices communicate by the language and protocols.

However, most of the IIoT devices use different protocols and data formats so that a direct communication between the devices is often not possible. Therefore, a communication between two devices is only possible if the two devices support the same protocols, respectively. Only a small part of devices may support all available protocols, which has various reasons. Many devices do not have enough memory capacity or computer performance to support different protocols, so that currently, many devices cannot communicate with each other.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, techniques that assist in improving communication between local devices connected in a network and to allow an automated communication (e.g., M2M communication) between the local devices are provided.

According to a first aspect, the present embodiments provide a system for data communication in a network between two or more local devices and a cloud computing platform, in which data collected and/or stored on at least one local device are transmitted to a cloud computing platform using at least one communication protocol a1, a2, . . . , an and processed by a translator module of the cloud computing platform. The data is transferred or transformed to at least one other communication protocol b1, b2, . . . , bn that is processable (e.g., understandable) by at least one second local device and submitted to the at least one second device.

Embodiments may be used, by way of example, for the communication and evaluation of, for example, vibration and other data in industrial plants, image data in the scientific and medical area, data for drug development and clinical trials using medical devices in the pharmaceutical sphere, data for route computations in the navigation field, data for image recognition in the automobile area and computer games, etc.

In further embodiments, the local devices and the cloud computing platform are connected by a gateway that is configured to transmit the data from the at least first local device with the first communication protocol a₁, a₂, . . . , aₙ to the cloud computing platform, and to submit the data with the second communication protocol b₁, b₂, . . . , bₙ from the cloud computing platform to the at least one second local device.

In another embodiment, the translation algorithm A includes sub-algorithms SA1, SA2, . . . SAn that are executable in a serial and/or parallel sequence.

Further, a workflow regarding the sequence and the location of the execution of the sub-algorithms SA1, SA2, . . . SAn may be controlled by a software application.

In one embodiment, the translation algorithm A is configured as a clustering and/or a neural network and/or a support vector machines and/or subdivided into sub-algorithms (SA1, SA2, . . . San).

In another embodiment, the processed data are collected from vibration sensors and/or acoustical sensors and/or optical sensors and/or temperature sensors and/or pressure sensors and/or chemical and/or piezoelectric sensors.

In one embodiment, a number of local devices are connected in the network.

In an embodiment, the two or more local devices are configured as an industrial pump, a medical device, an image device, mobile device, an automotive device, and/or an analytical scientific instrument.

According to a second aspect, the present embodiments provide a method data communication in a network between two or more local devices and a cloud computing platform. The method includes collecting and/or storing data on at least one local device, transmitting the data to a cloud computing platform using at least one communication protocol a₁, a₂, . . . , aₙ, and processing the data by a translator module of the cloud computing platform. The data is transformed (e.g., converted) to at least one other communication protocol b₁, b₂, . . . , bₙ that is executable by at least one second local device. The data is submitted with the other communication protocol b₁, b₂, . . . , bₙ to the at least one second device.

In another embodiment, the method may include connecting the local devices and the cloud computing platform by a gateway, and transmitting the data from the at least one first local device with the first communication protocol a₁, a₂, . . . , aₙ to the cloud computing platform by the gateway. The data is submitted with the second communication protocol b₁, b₂, . . . , bₙ from the cloud computing platform to the at least one second local device by the gateway.

Additionally, the present embodiments provide, according to a third aspect, a local device configured for a system according to the first aspect of the present embodiments, where the local device is configured as an industrial pump, a medical device, an image device, a mobile device, an automotive device, and/or an analytical scientific instrument.

According to a fourth aspect, the present embodiments provide a cloud computing platform configured for use in a system according the first aspect.

According to a fifth aspect, the present embodiments provide a computer program product including an executable program code configured to, when executed, perform the method according to the second aspect.

According to a sixth aspect, the present embodiments provide a non-transient computer-readable data storage medium including an executable program code configured to, when executed, perform the method according to the second aspect. The non-transient computer-readable data storage medium may include, or consist of, any type of computer memory (e.g., a semiconductor memory).

According to a seventh aspect, the present embodiments provide a data stream representing, or configured to provide, program code configured to, when executed, perform the method according to the second aspect.

### BRIEF DESCRIPTION OF THE DRAWINGS

FIG. 1 provides a general overview of a system according to an embodiment of a first aspect;

FIG. 2 shows a schematic flow diagram illustrating an embodiment of a method according to an embodiment of a second aspect;

FIG. 3 schematically illustrates a computer program product according to an embodiment of a fifth aspect; and

FIG. 4 schematically illustrates a non-transient computer-readable data storage medium according to an embodiment of a sixth aspect.

### DETAILED DESCRIPTION

In the following description, for purposes of explanation and not limitation, specific details are set forth in order to provide a thorough understanding of the present embodiments. It will be apparent to one skilled in the art that the present embodiments may be practiced in other implementations that depart from these specific details.

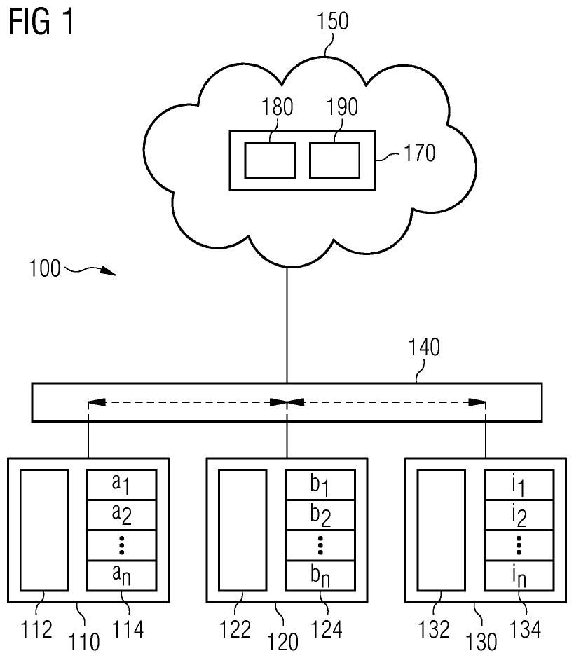

FIG. 1 provides a general overview of one embodiment of a system 100 for communication between a number of local devices 110, 120, 130 in a network of a cloud computing platform 150. The local devices 110, 120, 130 may be part of an industrial plant. Additional local devices (LD) may be added to the system 100. Examples of local devices are acceleration sensors to capture rotational and vibration data of an actuator, which helps in early detection of various failure modes encountered in rotation mechanical equipment. Other examples are medical devices in a healthcare environment or light and temperature sensors in a smart building or pressure sensors in the automotive area.

The devices 110, 120, 130 include, respectively, an IIoT agent 112, 122, and 132 and are connected to an IIoT gateway 140, which is connected by a network to an IIoT cloud computing platform 150. The network may include one or more wide area networks (WAN), such as Internet, local area networks (LAN), or other networks that may facilitate data communication.

If two or more devices 110, 120, 130 want to communicate directly with each other but do not have the same languages/formats in common the two or more devices 110, 120, 130 may use the service of a translator module 170 located in the cloud computing platform 150. The translator module 170 includes a processor 180 and other hardware components and a software application 190.

The device 110 may communicate with other devices using corresponding formats/protocols a₁, a₂, . . . , aₙ. The device 120 may communicate to other devices using corresponding formats/protocols b₁, b₂, . . . , bₙ. The device 130 may communicate to other devices using corresponding formats/protocols i₁, i₂, . . . , iₙ. However, if the protocols a₁, a₂, . . . , aₙ implemented in the first device 110 are not the same as the protocols b₁, b₂, . . . , bₙ implemented in the second device 120, it is not possible for the devices 110, 120, 130 to communicate directly with each other. Therefore, the first device 110 and the second device 120 send the data that the first device 110 and the second device 120 want to communicate to the other device via the gateway 140 to the cloud computing platform 150. In the cloud computing platform 150, the translator module 170 translates (e.g., converts) at least one of the protocols a₁, a₂, . . . , aₙ to at least one of the protocols b₁, b₂, . . . , bₙ of the second device. For example, the protocol a₁ is translated a transformed to the protocol b₃: a₁ \textcircled{7} b₃

This provides that the translator module 170 is to understand at least one protocol/language/format that is understood (e.g., processable or executable) by the first device 110 and at least one protocol/language/format that is understood (e.g., processable or executable) by the second device 120. If the translator module 170 knows one of the protocols a₁, a₂, . . . , aₙ of the first device and one of the protocols b₁, b₂, . . . , bₙ of the second device, a communication between the two devices 110, 120 may be performed. Therefore, the translator module 170 does not need or need to be able to process all protocols of the two devices, but is to be able to process at least one protocol from the first device 110 that may be translated or converted to at least one protocol of the other device 120. The protocol conversion may be performed in real time. Further, the protocol conversion may be logged for further analyzing the system.

Devices or systems that were not enabled to communicate with each other before may now communicate by an indirect communication by a third party (e.g., translator module 170) and therefore exchange data. By using this indirect communication, more devices or systems may communicate with each other.

Further, if for the communication of the local devices 110, 120, 130 the cloud computing platform 150 is used, a higher level of security for sensitive data may be provided, as the IIoT platform 150 may include a database regarding permission levels which devices are allowed to communicate with each other. Further, as the cloud computing platform may provide higher calculating speed and more memory space, the quality of the communication is higher and faster.

The local devices may be configured easier, as the local devices must not support many protocols originally. This saves design and developing expenditure as well as implementing expenditure, and therefore, costs. Further, the cloud computing platform 150 may include a number of other communication modules that may generate an automatic communication between specified local devices.

Therefore, according to the present embodiments, the software application 190 of the translator module 170 is configured to understand different protocols (e.g., capable of executing different protocols). The task of this software application 190 is to receive inquiries and to translate the inquiries into the required language or format. In a further embodiment, the software application 190 may include a second software application or may transmit the inquiry to a second application that may understand and process the language and is able to translate. The data transferred to or transformed into another communication protocol are submitted again directly to the local device 120 that is to be the receiver of the data message.

The translation algorithm (A) of the software application 190 may include sub-algorithms (SA1, SA2, . . . SAn) that are executable in a serial and/or parallel sequence. Further, a workflow regarding the sequence and the location of the execution of the sub-algorithms (SA1, SA2, . . . SAn) may be controlled by a further software application.

The translation algorithm (A) may be configured as a clustering and/or an artificial neural network and/or a support vector machines and/or subdivided into sub-algorithms (SA1, SA2, . . . SAn).

According to the present embodiments, devices of different manufacturers may communicate with each other. Complexity reduction may be achieved, as it is no longer necessary to support different protocols by one single local device. By using a third-party software application implemented in a cloud computing platform 150, different devices with different communication protocols may be connected to exchange data with each other.

Variously disclosed embodiments include data processing systems and methods that may be used to facilitate the translation of one communication protocol to another communication protocol. In one example, a system may include at least one processor configured via executable instructions included in at least one memory to initiate a plurality of translation tasks that are respectively executed by different processing resources. The translation tasks respectively manage respective subsets of communication protocols assigned to respective different local devices 110, 120, 130 to meet communication requirements. This also includes a determination if a communication between two local devices is to be performed with respect to security aspects.

Further, the network may be divided into sub-networks that allow access to all the other components connected to the network. The network may include an encryption scheme that may be employed over the public Internet. The network may be configured in a wired and/or wireless configuration that supports data transfer.

The displayed representation is intended to illustrate one possible configuration of the system 100. Other configurations may include fewer components, and in other configurations, additional modules may be utilized. These changes in configurations and components may increase or alter the capabilities of the system 100. Especially in the field of medical imaging, devices for capturing high-resolution medical images of a patient, such as magnetic resonance imaging (MRI) machines, computer tomography, x-ray, positron emission tomography, scanning microscopy, and ultrasound imaging systems, the sensors are configured to capture image data (e.g., sensors such as charged-coupled devices (CCD)). Further, other types of sensors such as acoustical, optical, piezoelectric, pressure, temperature, and chemical sensors may be used to collect additional data for a specific local device 110, 120, 130.

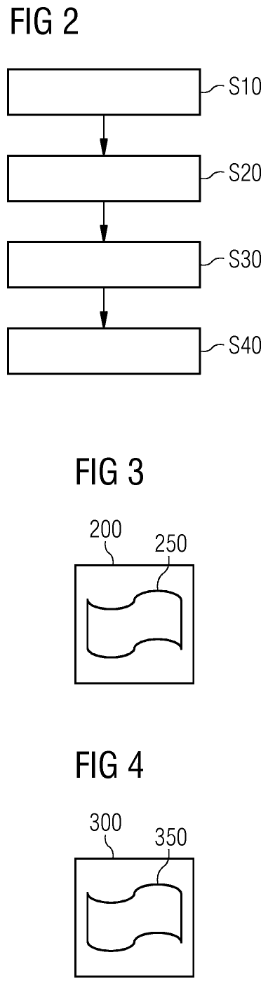

FIG. 2 shows a schematic flow diagram illustrating a method according to an embodiment of a second aspect. The method of FIG. 2 will be described partially using reference signs of FIG. 1, although the method of FIG. 2 is not restricted to the embodiments described in FIG. 1. The method of FIG. 2 may be executed using any of the embodiments described with respect to FIG. 1 and may, accordingly, be adapted and modified according to any variations and modifications described in the foregoing.

In act S10 of a method for data communication in a network between two or more local devices 110, 120, 130 and a cloud computing platform 150, data on at least one local device 110 is collected and/or stored.

In act S20, the data is transmitted to a cloud computing platform 150 using at least one communication protocol (a₁, a₂, . . . , aₙ).

In act S30, the received data is processed by a translation algorithm (A) in a translator module 170 of the cloud computing platform 150, where the data is transformed into at least one other communication protocol (b₁, b₂, . . . , bₙ) that is understandable or executable by at least one second local device 120. A cloud computing platform 150 according to a fourth aspect may be provided to perform the act S30, for example.

In act S40, the data is submitted with the other communication protocol (b₁, b₂, . . . , bₙ) to the at least one second device 120.

FIG. 3 schematically illustrates a computer program product 200 including executable program code 250 configured to, when executed, perform the method according to the second aspect (e.g., as has been described with respect to FIG. 2).

FIG. 4 schematically illustrates a non-transient computer-readable data storage medium 300 including executable program code 350 (e.g., instructions) configured to, when executed, perform the method according to the second aspect (e.g., as has been described with respect to FIG. 2).

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A system for data communication in a network between two or more local devices and a cloud computing platform, the system comprising:
the cloud computing platform; and
at least one first local device of the two or more local devices, the at least one first local device being configured to transmit data collected, stored, or collected and stored on the at least one first local device to the cloud computing platform using at least one communication protocol,
wherein a translator module of the cloud computing platform (150) is configured to process the data using a translation algorithm,
wherein the translation algorithm is configured as a clustering, an artificial neural network, a support vector machine, or any combination thereof,
wherein the translation algorithm comprises sub-algorithms that are executable in a serial, parallel, or serial and parallel sequence, the translation algorithm being subdivided into the sub-algorithms, and
wherein the data is transformed to at least one other communication protocol that is processable by at least one second local device of the two or more local devices and submitted to the at least one second local device.

2. The system of claim 1, wherein the two or more local devices and the cloud computing platform are connected by a gateway that is configured to:
transmit the data from the at least one first local device with the at least one communication protocol to the cloud computing platform: and submit the data with the at least one other communication protocol from the cloud computing platform to the at least one second local device.

3. (canceled)

4. The system of claim 1, wherein a workflow regarding the serial, parallel, or serial and parallel sequence and a location of an execution of the sub-algorithms is controlled by a software application.

5. (canceled)

6. The system of claim 1, wherein the processed data is collected from vibration sensors, acoustical sensors, optical sensors, temperature sensors, pressure sensors, chemical sensors, piezoelectric sensors, or any combination thereof.

7. The system of claim 1, wherein the two or more local devices comprise at least three local devices connected in the network.

8. The system of claim 1, wherein the two or more local devices are configured as an industrial pump, a medical device, an image device, a mobile device, an automotive device, an analytical scientific instrument, or any combination thereof.

9. A method for data communication in a network between two or more local devices and a cloud computing platform, the method comprising:
collecting, storing, or collecting and storing data on at least one first local device of the two or more local devices;
transmitting the data to a cloud computing platform using at least one communication protocol;
processing the data by a translator module of the cloud computing platform, wherein the data is transformed to at least one other communication protocol that is processable by at least one second local device of the two or more local devices; and
submitting the data with the at least one other communication protocol to the at least one second local device.

10. The method claim 9, further comprising:
connecting the two or more local devices and the cloud computing platform by a gateway;
transmitting the data from the at least one first local device with the at least one communication protocol to the cloud computing platform by the gateway; and
submitting the data with the at least one other communication protocol from the cloud computing platform to the at least one second local device by the gateway.

11. A local device configured for a system, the local device being configured as an industrial pump, a medical device, an image device, a mobile device, an automotive device, an analytical scientific instrument, or any combination thereof, and comprising:
a processor configured to:
transmit data collected, stored, or collected and stored on the local device to a cloud computing platform using at least one communication protocol, the data being processable in a translator module of the cloud computing platform, a translation algorithm being usable by the translator module to process the data,
wherein the translation algorithm is configured as a clustering, an artificial neural network, a support vector machine, or any combination thereof, and
wherein the data is transformable to at least one other communication protocol that is processable by another local device and submittable to the other local device.

12. A cloud computing platform comprising:
a translator module; and
a processor configured to:
process data collected, stored, or collected and stored on at least one local device and transmitted by the at least one local device to the cloud computing platform using at least one communication protocol,
wherein the processor is configured to execute the translator module to process the data using a translation algorithm,
wherein the translation algorithm is configured as a clustering, an artificial neural network, a support vector machine, or any combination thereof,
wherein the translation algorithm comprises sub-algorithms that are executable in a serial, parallel, or serial and parallel sequence, the translation algorithm being subdivided into the sub-algorithms, and
wherein the data is transformed to at least one other communication protocol that is processable by at least one other local device and submitted to the at least one other local device.

13. A non-transient computer-readable data storage medium that stores instructions executable by one or more processors for data communication in a network between two or more local devices and a cloud computing platform, the instructions comprising:
collecting, storing, or collecting and storing data on at least one first local device of the two or more local devices;
transmitting the data to a cloud computing platform using at least one communication protocol;
processing the data by a translator module of the cloud computing platform, wherein the data is transformed to at least one other communication protocol that is processable by at least one second local device of the two or more local devices; and
submitting the data with the at least one other communication protocol to the at least one second local device.

14. The non-transitory computer-readable storage medium of claim 13, wherein the instructions further comprise:
connecting the two or more local devices and the cloud computing platform by a gateway;
transmitting the data from the at least one first local device with the at least one communication protocol to the cloud computing platform by the gateway; and
submitting the data with the at least one other communication protocol from the cloud computing platform to the at least one second local device by the gateway.

15. The system of claim 2, wherein a workflow regarding the serial, parallel, or serial and parallel sequence and a location of an execution of the sub-algorithms is controlled by a software application.

16. The system of claim 15, wherein the processed data is collected from vibration sensors, acoustical sensors, optical sensors, temperature sensors, pressure sensors, chemical sensors, piezoelectric sensors, or any combination thereof.

17. The system of claim 16, wherein the two or more local devices comprise at least three local devices connected in the network.

18. The system of claim 2, wherein the two or more local devices are configured as an industrial pump, a medical device, an image device, a mobile device, an automotive device, an analytical scientific instrument, or any combination thereof.
